(19) United States
(12) Patent Application Publication
(10) Pub. No.: US 2008/0140399 A1
(43) Pub. Date: Jun. 12, 2008

(54) Method and system for high-speed speech recognition

(76) Inventor: Hoon Chung, Daejeon (KR)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/881,961

(22) Filed: Jul. 30, 2007

(30) Foreign Application Priority Data
Dec. 6, 2006 (KR) 2006-123153
Jun. 19, 2007 (KR) 2007-59710

(51) Int. Cl. G10L 15/00

(52) U.S. Cl. 704/240; 704/E15.014

(57) ABSTRACT

Provided is a method and system for high-speed speech recognition. On the basis of a continuous density hidden Markov model (CDHMM) using a Gaussian mixture model (GMM) for an observation probability, the method and system add only K Gaussian components highly contributing to a state-specific observation probability for an input feature vector and calculate the state-specific observation probability. Thus, in the aspect of the recognition ratio, the degree of approximation of a state-specific observation probability increases, thereby minimizing deterioration of speech recognition performance. In addition, in the aspect of the amount of computation, the number of addition operations required for computing an observation probability is reduced, in comparison with conventional speech recognition that adds all Gaussian probabilities of an input feature vector and uses it for a state-specific observation probability, thereby reducing the total amount of computation required for speech recognition.

### CROSS-REFERENCE TO RELATED APPLICATION

This application claims priority to and the benefit of Korean Patent Application Nos. 2006-123153 and 2007-59710, filed Dec. 6, 2006 and Jun. 19, 2007, the disclosure of which is incorporated herein by reference in its entirety.

### BACKGROUND

1. Field of the Invention

The present invention relates to a method and system for high-speed speech recognition, and more particularly, to a technique that minimizes the total amount of required computation by adding only K Gaussian probabilities highly contributing to the observation probability of a feature vector and calculating a state-specific observation probability, and thereby can improve speech recognition performance while performing high-speed speech recognition.

2. Discussion of Related Art

Speech recognition is a series of processes in which phonemes and linguistic information are extracted from acoustic information included in speech, and a machine recognizes and responds to them.

Speech recognition algorithms include dynamic time warping, neural network, hidden Markov model (HMM), and so on. Among these algorithms the HMM is an algorithm statistically modeling units of speech, i.e., phonemes and words. Since the HMM algorithm has a high capability of modeling a speech signal and high recognition accuracy, it is frequently used in the speech recognition field.

The HMM algorithm generates models representing training data from the training data using statistical characteristics of a speech signal according to time, and then adopts a probability model having a high similarity to the actual speech signal as a recognition result. The HMM algorithm is easily implemented to recognize isolated words, connected words and continuous words while showing good recognition performance, and thus is widely used in various application fields.

A speech recognition method using such an HMM algorithm comprises a preprocessing step and a recognition (or detection) step. An example of a method used in each step will now be described. First, in the preprocessing step, a feature parameter denoting an utterance feature is extracted from a speech signal. To this end, the preprocessing step comprises: a linear predictive coding (LPC) procedure including time alignment, normalization, and end-point detection processes; and a filter bank front-end procedure. Next, in the recognition step that is the core processing step of speech recognition, the extracted feature parameter of utterance is compared with feature parameters of words stored in a pronunciation dictionary during a training step on the basis of a Viterbi decoding algorithm, and thereby the best matching utterance sequence is found.

The HMM is classified into discrete HMM, semi-continuous HMM and continuous density HMM (CDHMM) according to the kind of observation probability used. Among them, the CDHMM using a Gaussian mixture model (GMM) as an observation probability model of each state is frequently used because it has high recognition performance.

However, the CDHMM requires a huge amount of computation to calculate all observation probabilities for an input feature vector using a GMM that is a state-specific observation probability. Thus, Gaussian selection (GS) is suggested as a general method for reducing the amount of computation.

According to the GS, probabilities are actually only calculated for Gaussian components located adjacent to an input feature vector, and a previously defined constant is used for Gaussian components located far away from the input feature vector.

However, according to such a GS method, the same constant is allocated to all the Gaussian components located far away from the input feature vector regardless of the degree of proximity, thus deteriorating discrimination between observation probabilities. Consequently, the GS method deteriorates recognition performance.

### SUMMARY OF THE INVENTION

The present invention is directed to a method and system for speech recognition capable of high-speed speech recognition by minimizing the amount of computation without deteriorating recognition performance.

One aspect of the present invention provides a system for high-speed speech recognition, comprising: a preprocessor for extracting a speech section from an input speech signal; a feature vector extractor for extracting a speech feature vector from the extracted speech section; a Gaussian probability calculator for computing Gaussian probabilities for the extracted speech feature vector; a state-based approximator for computing a state-specific observation probability using a Gaussian component having the highest of the computed Gaussian probabilities for the speech feature vector and K Gaussian components adjacent to the Gaussian component; and a speech recognizer for computing a similarity using the computed state-specific observation probability, and performing speech recognition.

Another aspect of the present invention provides a method for high-speed speech recognition, comprising the steps of: extracting a speech section from an input speech signal; extracting a speech feature vector from the extracted speech section; computing respective Gaussian probabilities for the extracted speech feature vector; computing a state-specific observation probability using a Gaussian component having the highest of the computed Gaussian probabilities for the speech feature vector and K Gaussian components adjacent to the Gaussian component; and computing a similarity using the computed state-specific observation probability and performing speech recognition.

### BRIEF DESCRIPTION OF THE DRAWINGS

The above and other objects, features and advantages of the present invention will become more apparent to those of ordinary skill in the art by describing in detail preferred embodiments thereof with reference to the attached drawings, in which:

FIG. 1 is a block diagram of a system for high-speed speech recognition according to an exemplary embodiment of the present invention; and

FIG. 2 is a flowchart showing a method for high-speed speech recognition according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

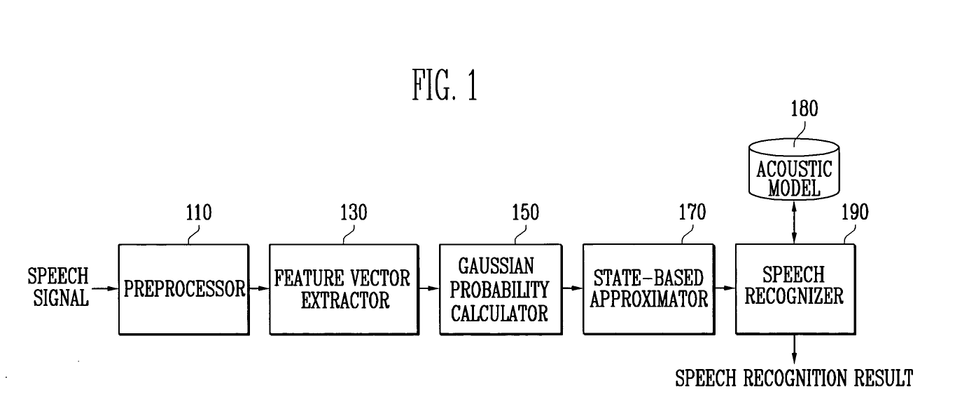

FIG. 1 is a block diagram of a system for high-speed speech recognition according to an exemplary embodiment of the present invention.

As illustrated in FIG. 1, the speech recognition system according to an exemplary embodiment of the present invention comprises a preprocessor 110, a feature vector extractor 130, a Gaussian probability calculator 150, a state-based approximator 170, an acoustic model 180, and a speech recognizer 190. The preprocessor 110 extracts a speech section from an input speech signal. The feature vector extractor 130 extracts a speech feature vector from the extracted speech section. The Gaussian probability calculator 150 computes Gaussian probabilities for the speech feature vector. The state-based approximator 170 computes a state-specific observation probability using a Gaussian component having the highest of the computed Gaussian probabilities and K Gaussian components adjacent to the Gaussian component. The acoustic model 180 is for speech recognition. The speech recognizer 190 computes a similarity using the computed state-specific observation probability, thereby performing speech recognition.

The preprocessor 110 detects the end point of an input speech signal, thereby extracting a speech section. Since such a speech-section extraction method has been disclosed in conventional art, the present invention will be easily understood by those skilled in the art without a detailed description thereof.

The feature vector extractor 130 may extract a feature vector of a speech signal included in the speech section using at least one of, for example, linear predictive coding (LPC) feature extraction, perceptual linear prediction cepstrum coefficient (PLPCC) feature extraction, and Mel-frequency cepstrum coefficient (MFCC) feature extraction.

The present invention has a most remarkable characteristic in that when an observation probability for an extracted feature vector is calculated in a speech recognition system based on a continuous density hidden Markov model (CDHMM) using a Gaussian mixture model (GMM) as a state observation probability, it minimizes the amount of computation using state-based approximation according to the degree of proximity without deteriorating speech recognition performance, as described below. In order to aid understanding of the present invention, first, the GMM is briefly described now.

The GMM is a model in which M Gaussian probability densities are combined. When an equivalent feature vector O having a length T is independently distributed, a GMM probability P(O) for the feature vector O may be expressed by Formula 1 below.

$$\begin{matrix}P ( O ) = {\sum }_{m = 1}^{M} {w}_{m} N ( O , {μ}_{m} , {\sum }_{m} ) \\ = {w}_{1} N ( O , {μ}_{1} , {\sum }_{1} ) + {w}_{2} N ( O , {μ}_{2} , {\sum }_{2} ) + … + \\ {w}_{M} N ( O , {μ}_{M} , {\sum }_{M} )\end{matrix} \qquad [ Formula 1 ]$$

In Formula 1, O denotes a speech feature vector, M denotes the number of the total Gaussian components, wₘ denotes the weight of an m-th Gaussian component, and N(O,μₘ,Σₘ) denotes a multivariate Gaussian distribution having an average μₘ and a distribution Σₘ.

In other words, when the GMM consists of M Gaussian components, addition of a Gaussian probability is performed M times in total. Here, assuming that Pₘ(O) denotes the sum of a first Gaussian probability to an m-th one, Pₘ(O) may be expressed by Formula 2 below.

$$\begin{matrix}{P}_{m} ( O ) = {w}_{1} N ( O , {μ}_{1} , {\sum }_{1} ) + {w}_{2} N ( O , {μ}_{2} , {\sum }_{2} ) + … + \\ {w}_{m} N ( O , {μ}_{m} , {\sum }_{m} ) \\ = {P}_{m - 1} ( O ) + {w}_{m} N ( O , {μ}_{m} , {\sum }_{m} ) ,\end{matrix} \\ where {P}_{0} ( O ) = 0 , 1 \leq m \leq M \qquad [ Formula 2 ]$$

In Formula 2, Pₘ₋₁(O) denotes the sum of a first Gaussian probability to an (m−1)th one, and wₘN(O,μₘ,Σₘ) denotes an m-th Gaussian probability.

However, when the observation probability of a GMM is calculated by Formula 2 in an actual speech recognition system, the probability is so small as to cause underflow. To prevent this, the observation probability is calculated in the log domain by Formula 3 below.

$$log {P}_{m} ( O ) = log {P}_{m - 1} ( O ) + log {w}_{m} N ( O , {μ}_{m} , {\sum }_{m} ) \qquad [ Formula 3 ]$$

In Formula 3, N(O,μₘ,Σₘ) denotes a multivariate Gaussian distribution, which is defined by Formula 4 below.

$$N ( O , {μ}_{m} , {\sum }_{m} ) = \frac{1}{\sqrt{{( 2 π )}^{″} \vert {\sum }_{m} \vert}} {e}^{- 1 / 2 ( O - μ ) {\sum }^{- 1} ( O - μ )} \qquad [ Formula 4 ]$$

(here, n denotes the dimension of a feature vector sequence)

Since N(O,μₘ,Σₘ) of Formula 4 is defined by an exponential function, a natural logarithm is applied to Formula 3 for convenience, and Formula 3 may be expressed by Formula 5 below.

ln(a+b)=ln a+ln(1+exp(ln b−ln a)) [Formula 5]

In Formula 5, a denotes log(Pₘ₋₁(O)), and b denotes log(wₘN(O,μₘ,Σₘ)).

In other words, when the observation probability of a GMM for a speech feature vector is calculated in the log domain, logarithmic addition of a GMM consisting of Gaussian distributions needs to be performed M times, as shown in Formula 5. In addition, while the desired result value is a GMM probability to which a logarithm is applied once, as shown in Formula 3, a probability to which the natural logarithm as well as the logarithm is applied is obtained by Formula 5. Thus, the obtained probability must be changed back into an exponential function and a logarithm is applied again. Consequently, in a recognition step using a Viterbi decoding algorithm, the amount of computation unnecessarily increases, and speech recognition takes more time.

Therefore, in the present invention, to reduce the amount of computation, Gaussian probabilities for a speech feature vector are calculated, and then only K Gaussian components most highly contributing to an observation probability among them are added, thereby calculating a state-specific observation probability. Thus, the amount of the above-mentioned logarithmic addition operation is reduced, which enables high-speed speech recognition. In association with this, an observation probability computation method using state-based approximation will be described in further detail below.

First, the observation probability computation using state-based approximation according to the present invention comprises 3 steps. In the first step, respective Gaussian probabilities for a speech feature vector are computed. In the second step, a Gaussian component having the highest of the computed Gaussian probabilities and K Gaussian components adjacent to the Gaussian component are added, thereby computing a state-specific observation probability. In the third step, a similarity is calculated using the computed state-specific observation probability, thereby performing speech recognition. The respective steps will be described in further detail below.

(1) Compute Gaussian Probabilities for a Speech Feature Vector

In the first step, the Gaussian probability calculator 150 computes respective Gaussian probabilities for the speech feature vector O using Formula 4.

(2) Compute a State-Specific Observation Probability Using State-Based Approximation

In the second step, the state-based approximator 170 selects a Gaussian component having the highest of the computed Gaussian probabilities and K Gaussian components adjacent to the Gaussian component using Formula 6 below, and then adds the selected Gaussian components, thereby computing a state-specific observation probability.

K_{s,m}=arg minᵢ(k){δ(Nₛ(m),Nₛ(i)} 1≦i,m≦M, i≠m [Formula 6]

In Formula 6, K_{s,m} denotes a set of K Gaussian components adjacent to an m-th Gaussian component Nₛ(m) in a state S, and arg minᵢ(k) denotes selecting of the K Gaussian components adjacent to the m-th Gaussian component Nₛ(m) according to a distance measurement function δ(i, j) given in the state S.

To obtain K Gaussian components adjacent to a Gaussian component having the highest probability, all Gaussian probabilities may be sorted in order of size, and top K Gaussian probabilities among them may be selected. According to the method, however, the amount of computation increases due to the sorting operation.

To solve this problem, the present invention obtains information on the K Gaussian components located adjacent to each of all the Gaussian components as shown in Formula 6, and incorporates the information into each set.

Since a Gaussian component having the highest probability for an input feature vector can be easily obtained without a sorting operation, K Gaussian components located adjacent to the Gaussian component having the highest probability can be selected directly from the previously constructed set.

Here, according to which distance measurement function is used in Formula 6, K Gaussian components adjacent to each Gaussian component may be selected differently. In the present invention, a distance between Gaussian distributions is measured using a Euclidean distance function, a weighted Euclidean distance function, and a Bhattacharyya distance function as shown in Formula 7 below.

$${δ}_{e} ( N ( i ) , N ( j ) ) = \sqrt{{\sum }_{d = 1}^{D} {( {μ}_{i} ( d ) - {μ}_{j} ( d ) )}^{2}} \\ {δ}_{w} ( N ( i ) , N ( j ) ) = \frac{1}{N} {\sum }_{d = 1}^{D} \frac{{( {μ}_{i} ( d ) - {μ}_{j} ( d ) )}^{2}}{\sqrt{{σ}_{i}^{2} ( d ) {σ}_{j}^{2} ( d )}} \\ {δ}_{b} ( N ( i ) , N ( j ) ) = \frac{1}{8} {{( {μ}_{i} - {μ}_{j} )}^{T} [ \frac{{\sum }_{i} + {\sum }_{j}}{2} ]}^{- 1} ( {μ}_{i} - {μ}_{j} ) + \frac{1}{2} ln \frac{[ \frac{{\sum }_{i} + {\sum }_{j}}{2} ]}{\sqrt{\vert {\sum }_{i} \vert \vert {\sum }_{j} \vert}} \qquad [ Formula 7 ]$$

In Formula 7, δₑ(N(i), N(j)) denotes a Euclidean distance function, δ_{w}(N(i), N(j)) denotes a weighted Euclidean distance function, and δ_{b}(N(i), N(j)) denotes a Bhattacharyya distance function.

When the Gaussian probability calculator 150 computes respective Gaussian probabilities for a speech feature vector in the case where information on K Gaussian components located adjacent to each Gaussian component constituting a state-specific GMM has been previously incorporated into a set, the state-based approximator 170 adds a Gaussian component having the highest observation probability among the computed Gaussian probabilities and K Gaussian components adjacent to the Gaussian component, thereby computing a state-specific observation probability.

In this way, a Gaussian component having the highest observation probability and K Gaussian components adjacent to the Gaussian component are always included in state-specific observation probability computation. Therefore, in comparison with a Gaussian selection (GS) method allocating the same constant to all Gaussian components far away from an input feature vector, it is possible to increase the degree of approximation of a state-specific observation probability and thus minimize deterioration of speech recognition performance. Also, as for the amount of computation, while the GS method needs the operation of adding a Gaussian probability M times, the present invention needs the operation of adding only K Gaussian components, thus reducing the amount of computation corresponding to (M-K).

(3) Recognize Speech Using a State-Specific Observation Probability

In the third step, the speech recognizer 190 computes a similarity using the computed state-specific observation probability on the basis of the Viterbi decoding algorithm, thereby performing speech recognition.

As described above, the system for speech recognition according to an exemplary embodiment of the present invention calculates respective Gaussian probabilities for a speech feature vector and then adds K Gaussian components most highly contributing to an observation probability among them, thereby calculating the state-specific observation probability. Thus, by reducing the total amount of computation required for observation probability computation, it is possible to improve speech recognition performance while enabling high-speed speech recognition.

A method for high-speed speech recognition according to an exemplary embodiment will be described in detail below.

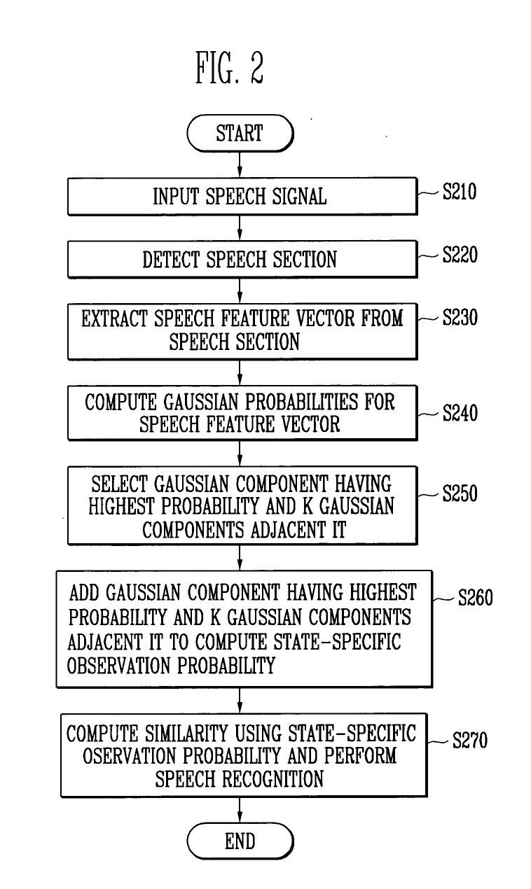

FIG. 2 is a flowchart showing a method for high-speed speech recognition according to an exemplary embodiment of the present invention.

First, when a speech signal is input (step 210), the end point of the input speech signal is detected, and a speech section is extracted (step 220).

Subsequently, a feature vector of the speech signal included in the speech section is extracted (step 230). Here, LPC feature extraction, PLPCC feature extraction and MFCC feature extraction may be used as a speech feature vector extraction method as described above.

Subsequently, Gaussian probabilities for the extracted speech feature vector are computed (step 240), and then a Gaussian component having the highest of the computed Gaussian probabilities and K Gaussian probabilities adjacent to the Gaussian probability are selected (step 250).

Here, selection of a Gaussian component having the highest of the computed Gaussian probabilities and K Gaussian probabilities adjacent to the Gaussian probability has been described in detail with reference to Formula 6, and thus will not be reiterated.

Subsequently, the selected Gaussian component having the highest of the computed Gaussian probabilities and the selected K Gaussian probabilities adjacent to the Gaussian probability are added, thereby computing a state-specific observation probability (step 260). Then, a similarity is computed using the computed state-specific observation probability on the basis of the Viterbi decoding algorithm, thereby performing speech recognition (step 270).

In other words, the method for speech recognition according to an exemplary embodiment of the present invention calculates an observation probability by adding K Gaussian components highly contributing to the observation probability among several Gaussian probabilities constituting a state-specific GMM for an extracted speech feature vector. Thus, by minimizing the total amount of computation required for observation probability calculation, the method does not deteriorate speech recognition performance while enabling high-speed speech recognition.

Meanwhile, the above-described exemplary embodiments can be written as a program that can be executed by computers, and can be implemented in general-purpose computers executing the program using a computer-readable recording medium.

The computer-readable recording medium may be a magnetic storage medium, e.g., a read-only memory (ROM), a floppy disk, a hard disk, etc., an optical reading medium, e.g., a compact disk read-only memory (CD-ROM), a digital versatile disc (DVD), etc., and carrier waves, e.g., transmission over the Internet.

As described above, according to the present invention, the total amount of computation required for observation probability calculation is minimized, and thus it is possible to improve speech recognition performance while enabling high-speed speech recognition.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A system for high-speed speech recognition, comprising:
a preprocessor for extracting a speech section from an input speech signal;
a feature vector extractor for extracting a speech feature vector from the extracted speech section;
a Gaussian probability calculator for computing respective Gaussian probabilities for the extracted speech feature vector;
a state-based approximator for computing a state-specific observation probability using a Gaussian component having the highest of the computed Gaussian probabilities for the speech feature vector and K Gaussian components adjacent to the Gaussian component; and
a speech recognizer for computing a similarity using the computed state-specific observation probability and performing speech recognition.

2. The system of claim 1, wherein the state-based approximator selects the Gaussian component having the highest of the Gaussian probabilities for the speech feature vector, selects the K Gaussian components adjacent to the selected Gaussian component having the highest Gaussian probability according to a state and a distance measurement function, and then adds the Gaussian component having the highest Gaussian probability and the K Gaussian components adjacent to the Gaussian component having the highest Gaussian probability to compute the state-specific observation probability for the speech feature vector.

3. The system of claim 2, wherein the state-based approximator selects the K Gaussian components adjacent to the Gaussian component having the highest Gaussian probability according to one distance measurement function of a Euclidean distance function, a weighted Euclidean distance function, and a Bhattacharyya distance function.

4. The system of claim 1, wherein information on K Gaussian components adjacent to each Gaussian component constituting a Gaussian mixture model (GMM) is previously incorporated into a set.

5. A method for high-speed speech recognition, comprising the steps of:
extracting a speech section from an input speech signal;
extracting a speech feature vector from the extracted speech section;
computing respective Gaussian probabilities for the extracted speech feature vector;
computing a state-specific observation probability using a Gaussian component having the highest of the computed Gaussian probabilities for the speech feature vector and K Gaussian components adjacent to the Gaussian component having the highest Gaussian probability; and
computing a similarity using the computed state-specific observation probability and performing speech recognition.

6. The method of claim 5, before the step of extracting a speech section from an input speech signal, further comprising the step of:
previously incorporating information on K Gaussian components adjacent to each Gaussian component constituting a Gaussian mixture model (GMM) into a set.

7. The method of claim 5, wherein in the step of computing respective Gaussian probabilities for the extracted speech feature vector, the respective Gaussian probabilities for the extracted speech feature vector are calculated by a formula below:
$$N ( O , {μ}_{m} , {\sum }_{m} ) = \frac{1}{\sqrt{{( 2 π )}^{″} \vert {\sum }_{m} \vert}} {e}^{- 1 / 2 ( O - μ ) {\sum }^{- 1} ( O - μ )}$$
wherein O denotes a speech feature vector, wₘ denotes a weight of an m-th Gaussian component, N(O,μₘ,Σₘ) denotes a multivariate Gaussian distribution having an average μₘ and a distribution Σₘ, and n denotes a dimension of a feature vector sequence.

8. The method of claim 5, wherein the step of computing a state-specific observation probability further comprises the steps of:
selecting the Gaussian component having the highest of the computed Gaussian probabilities for the speech feature vector;
selecting the K Gaussian components adjacent to the Gaussian component having the highest Gaussian probability according to a state and a distance measurement function; and
adding the selected Gaussian component having the highest Gaussian probability and the selected K Gaussian components adjacent to the Gaussian component having the highest Gaussian probability to compute the state-specific observation probability for the speech feature vector.

9. The method of claim 8, wherein the distance measurement function is one of a Euclidean distance function, a weighted Euclidean distance function, and a Bhattacharyya distance function.

10. The method of claim 5, wherein the step of performing speech recognition further comprises the step of:
computing the similarity using the computed state-specific observation probability on the basis of a Viterbi decoding algorithm.
